(19) United States
(12) Patent Application Publication
(10) Pub. No.: US 2019/0000215 A1
(43) Pub. Date: Jan. 3, 2019

(54) Pumping-Type Cosmetic Container Having Applicator Part

(71) Applicant: YONWOO CO., LTD., Incheon (KR)

(72) Inventors: Su-Jin Son, Incheon (KR); Min-Goo Kim, Incheon (KR); Jung-yeon Seo, Incheon (KR)

(21) Appl. No.: 16/065,501

(22) PCT Filed: Oct. 25, 2016
(86) PCT No.: PCT/KR2016/012012

§ 371 Date: Jun. 22, 2018

(30) Foreign Application Priority Data
Dec. 30, 2015 (KR) 10-2015-0189721

(51) Int. Cl. A45D 34/06; A45D 34/04; A45D 40/24

(52) U.S. Cl. CPC A45D 34/06; A45D 34/041; A45D 34/042; B05B 11/00418; A45D 2200/055; A45D 2200/1018; A45D 40/24

(57) ABSTRACT

A pumping-type cosmetic container having a metal applicator part, particularly, a pumping-type cosmetic container in which a bottom surface structure of a container body is modified and an applicator part having functions of contents application and massage is coupled thereto, such that contents can be discharged while providing the same usability as a conventional pumping-type cosmetic container, and thus, it is possible to apply contents onto the skin and to massage the skin through the application part coupled to the bottom surface of the container body, thereby providing user convenience.

### BACKGROUND OF THE INVENTION

The present invention relates to a pumping-type cosmetic container having a metal applicator part, particularly, a pumping-type cosmetic container wherein a bottom surface structure of a container body thereof is modified and an applicator part having functions of contents application and massage is coupled thereto, such that contents can be discharged while providing the same usability as a conventional pumping-type cosmetic container, and thus, it is possible to apply contents onto the skin and to massage the skin through the application part coupled to the bottom surface of the container body, thereby providing user convenience.

Generally, pumping-type cosmetics containers are configured in that a pumping member is disposed at the upper portion of a container body and thereby contents can be discharged to the outside by means of pumping operation of a pumping means. This pumping-type cosmetic container is disclosed in FIG. 1 of the registered utility model No. 20-02358459 (Hereafter is called as the registered utility model).

Referring to the registered utility model in the above, conventional pumping-type cosmetic containers comprises a container part (3) storing contents and a pumping part (1) coupled to an upper end of the container part (3) and discharging the contents stored in the container part (3), wherein the pumping part (1) includes a cap coupled to the upper end of the container part (3) and a button (50) coupled to the cap capable of being lifted and lowered and formed with a discharge outlet (53) at the interior therein, wherein at the interior of the cap is provided a housing (10) downwardly extending to the contents filled in the container part (3), and are respectively provided a piston rod (20) and a seal cap (30) connected to a stem (57) at the lower portion of the button (50) and discharging the contents flowing to the housing (10) while being lifted at the interior of the housing (10). Furthermore, a contents inflow hole (11) opened and closed by a ball (70) is provided at the lower end portion of the housing (10) and a spring (80) upwardly supporting the piston rod (20) between the contents inflow hole (11) and the piston rod (20).

However, the registered utility model with the above constitution is configured to discharge contents simply by means of pumping operation of the pumping part (1). Therefore, due to absence of the means for applying the discharged contents over the skin, a user should have a separate applicator to apply contents over the skin, thereby leading to user inconvenience.

### SUMMARY OF THE INVENTION

The present invention is devised to solve the problems described in the above, the objectives of the present invention is to provide a pumping-type cosmetic container wherein a bottom surface structure of a container body thereof is modified and an applicator part having functions of contents application and massage is coupled thereto, such that contents can be discharged while providing the same usability as a conventional pumping-type cosmetic container, and also it is possible to apply contents onto the skin and to massage the skin through the application part coupled to the bottom surface of the container body, thereby providing user convenience.

To solve the problems in the above, a pumping-type cosmetic container having a metal applicator part according to the present invention includes: a container body where contents are stored; a pumping member coupled to the upper portion of the container body and discharging the contents stored in the container body by means of pumping operation; a fixation body coupled as encasing the pumping member at the upper portion of the container body, and fixing the pumping member to the upper portion of the container body; and a button member disposed at the upper portion of the pumping member, and delivering pressure to the pumping member according to a user's pressurization, and inducing the pumping operation,

characterized in that an applicator part which applies contents onto the skin is coupled to the lower end of the container body, and contents stored in the container body are discharged through pumping operation of the pumping member, and then the contents can be applied onto the skin through the applicator part coupled to the lower end of the container body.

Furthermore, it is characterized in that the applicator part includes a contents-applying member which applies contents onto user's skin; a coupling part closing the lower end of the container body and coupled; a fixation part which extends from the lower end of the coupling part to the lower direction and forming a space where the contents-applying member is inserted, and fixing the contents-applying member inserted; and a finishing cap encasing the contents-applying member and detachably coupled to the fixation part.

Furthermore, it is characterized in that at the outer circumferential surface of the coupling part of the applicator part is formed an air movement groove which moves air to the inner side of the container body such that a piston installed at the lower inner side of the container body can ascend according to the contents usage.

Furthermore, it is characterized in that the contents-applying member is made of any of a brush, a ball, a metal tip, a rubber tip or a puff.

Meanwhile, a pumping-type cosmetic container having a metal applicator part according to the present invention includes: a container body where contents are stored; a pumping member coupled to the upper portion of the container body and discharging the contents stored in the container body by means of pumping operation; a fixation body coupled as encasing the pumping member at the upper portion of the container body, and fixing the pumping member to the upper portion of the container body; and a button member disposed at the upper portion of the pumping member, and delivering pressure to the pumping member according to a user's pressurization, and inducing the pumping operation,

characterized in that the contents of stick-type, different from the contents stored in the container body, are coupled at the lower end of the container body, and the color makeup is followed through the contents of stick-type coupled to the lower end of the container body after the foundation makeup is applied by discharging contents stored in the container body through the pumping member according to the manipulation of the button member.

As described in the above, according to the present invention, a bottom surface structure of a container body of a pumping-type cosmetic container is modified and an applicator part having functions of contents application and massage is coupled thereto, such that contents can be discharged while providing the same usability as a conventional pumping-type cosmetic container, and thus, it is possible to apply contents onto the skin and to massage the skin through the application part coupled to the bottom surface of the container body, thereby providing user convenience.

Furthermore, when buying a cosmetic container, a user can selectively buy a container equipped with a contents-applying member that can be often used while applying the contents stored in the container, such that the user need not take an applicator suitable for the contents whenever putting on makeup, thereby having convenience,

### BRIEF DESCRIPTION OF THE DRAWINGS

FIG. 1 is an exploded perspective view illustrating a configuration of a pumping-type cosmetic container having a metal applicator part according to an exemplary embodiment of the present invention.

FIG. 2 is an assembled perspective view illustrating a configuration of a pumping-type cosmetic container having a metal applicator part according to an exemplary embodiment of the present invention.

FIG. 3 is an assembled cross-sectional view illustrating a configuration of a pumping-type cosmetic container having a metal applicator part according to an exemplary embodiment of the present invention.

FIG. 4 is an assembled cross-sectional view illustrating various configurations of a pumping-type cosmetic container having a metal applicator part according to an exemplary embodiment of the present invention.

FIGS. 5A and 5B are explanatory views illustrating a using method of a pumping-type cosmetic container having a metal applicator part according to an exemplary embodiment of the present invention.

### DETAILED DESCRIPTION OF PREFERRED EMBODIMENTS

Hereinafter, the present invention will be described in detail with reference to the accompanying drawings. The same reference numerals provided in the drawings indicate the same members.

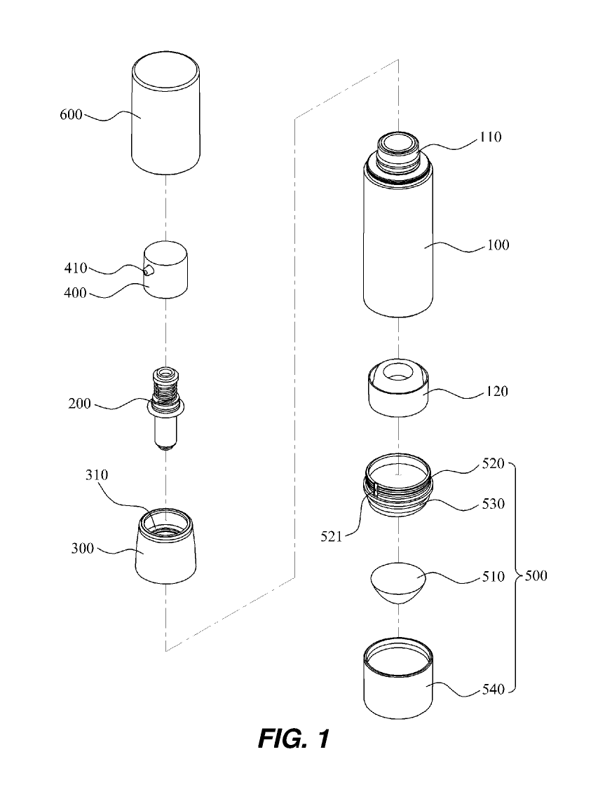

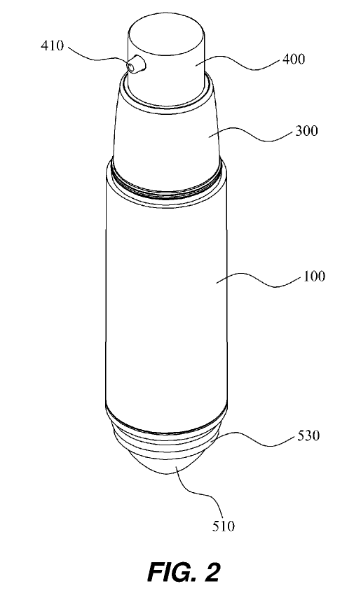

FIG. 1 is an exploded perspective view illustrating a configuration of a pumping-type cosmetic container having a metal applicator part according to an exemplary embodiment of the present invention. FIG. 2 is an assembled perspective view illustrating a configuration of a pumping-type cosmetic container having a metal applicator part according to an exemplary embodiment of the present invention.

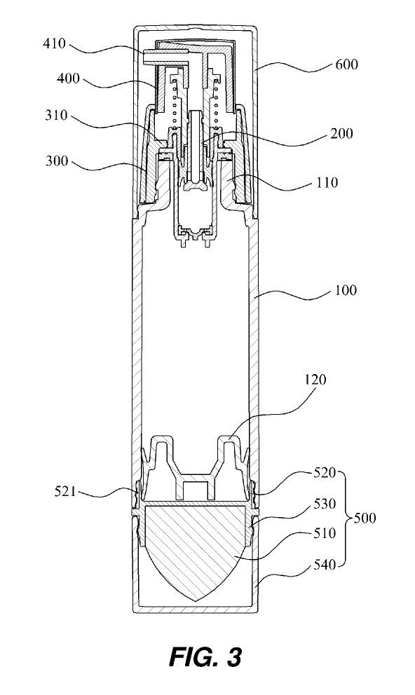

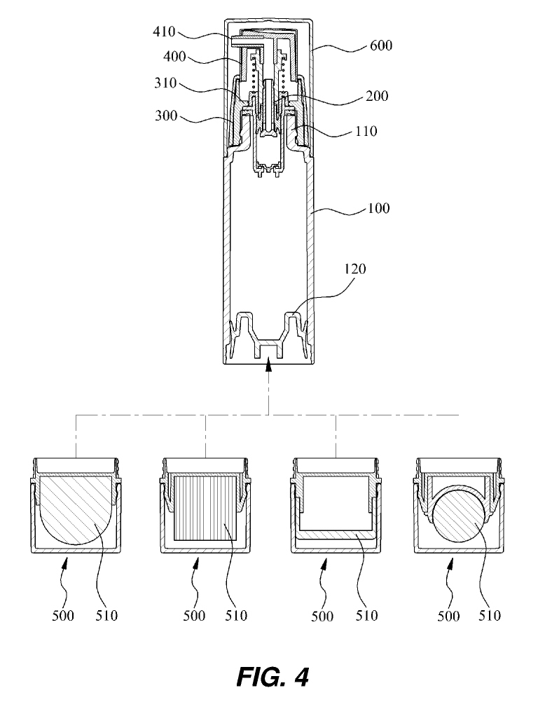

FIG. 3 is an assembled cross-sectional view illustrating a configuration of a pumping-type cosmetic container having a metal applicator part according to an exemplary embodiment of the present invention. FIG. 4 is an assembled cross-sectional view illustrating various configurations of a pumping-type cosmetic container having a metal applicator part according to an exemplary embodiment of the present invention.

Referring to FIGS. 1 to 4 a pumping-type cosmetic container having a metal applicator part according to exemplary embodiments of the present invention includes a container body 100, a pumping member 200, a fixation body 300, a button member 400, and an applicator part 500.

The container body 100, where contents are stored, is provided with a discharge part 110 at the upper portion thereof such that contents can be discharged, and at the inner side thereof is installed a piston 120 which ascends according to the contents being used.

The present invention is characterized in that an applicator part 500, to be described later, is coupled at the lower end of the container body 100 and is formed with the lower end open such that the applicator part 500 can be coupled thereto.

Meanwhile, an over cap 600, which is detachably coupled as encasing the fixation body 300 and the button member 400, is provided at the upper portion of the container body 100.

The pumping member 200 is coupled to the upper portion of the container body 100 and discharges the contents stored in the container body 100 through the pumping operation. Since the pumping member 200 belongs to the prior art in the technological field of the present invention, detailed description will be omitted.

The fixation body 300, coupled at the upper portion of the container body 100 as encasing the pumping member 200 and fixing the pumping member 200 at the upper portion of the container body 100, is provided with a fixation projection 310 as encasing the inner circumferential surface of the pumping member 200 as as to fix the pumping member 200.

The button member 400, which is disposed at the upper portion of the pumping member 200, delivering pressure to the pumping member 200 according to user's pressurization and inducing pumping operation, is formed with a discharge outlet 410 at the front surface such that contents can be discharged to the outside by the pumping operation.

The application part 500, which is coupled to the lower end of the container body 100 and applies the contents discharged through the pumping operation of the pumping member 200 onto the skin according to manipulation of the button member 400, includes a contents-applying member 510, a coupling part 520, a fixation part 530, and a finishing cap 540.

The contents-applying member 510, which is fixedly installed at the lower end of the container body 100 by a fixation part 530, to be described later, and applies contents onto user's skin, can be made of various applying members, such as a brush, a ball, a metal tip, a rubber tip, or a puff, which is capable of applying contents onto the skin, as illustrated in FIG. 4.

The contents-applying member 510 is integrally coupled to the lower end of the container body 100; thus, a user need not take an applicator whenever putting on makeup, thereby having user's convenience.

The coupling part 520 is coupled to the inner side of the container body 100 as closing the lower end of the container body and fixes the applicator part 500 to the lower end of the container body 100. The present invention is characterized in that an air movement groove 521 is formed at the outer circumferential surface of the coupling part 520 such that external air can move to the inner side of the container body 100.

The air movement groove 521, a pair of which are installed at both sides of the coupling part 520, forms a space where air can move to the interior of the container body 100. Due to this, it is possible for a piston 120 which is installed at the inner lower side of the container body 100 to ascend according to the contents being used.

The fixation part 530, which extends to the downward direction from the lower end of the coupling part 520 and forms a space where the contents-applying member 510 can be inserted and fixes the contents-applying member 510 being inserted, can be composed into various shapes which corresponds to the shape of the contents-applying member 510 being inserted.

It is preferable that a separation-preventing means is equipped at the fixation part 530 such that the contents-applying member 510 inserted can be prevented from being separated.

The finishing cap 540, which encases the contents-applying member 510 and is detachably coupled to the fixation part 530, protects the contents-applying member 510 from the external impact and prevent the contents-applying member 510 from being stained with foreign substances.

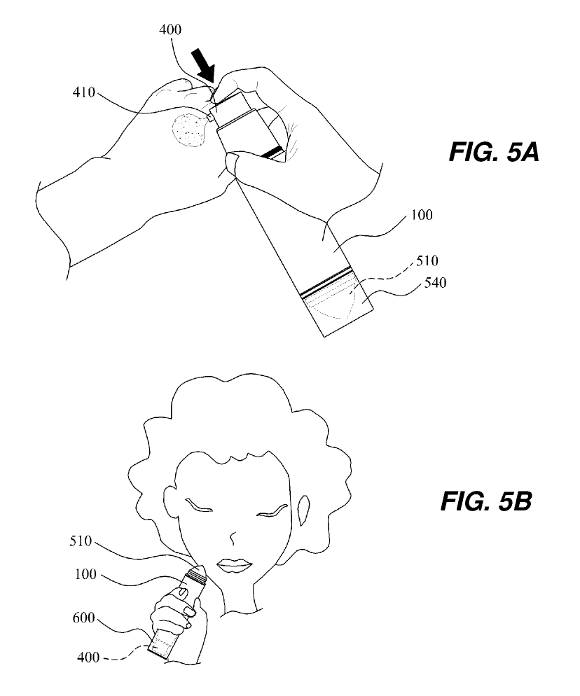

Hereafter, with reference of FIGS. 5A and 5B, a using method of a pumping-type cosmetic container having a metal applicator part according to an exemplary embodiment of the present invention will be explained. Referring FIGS. 5A and 5B, first, pressurize the button member 400 in a state of the container body 100 being erected and discharge contents through the discharge outlet 410. The contents discharged at this time can be discharged directly onto user's facial skin. However, it is preferable to discharge the contents onto user's hand.

As in the above, when the contents are discharged on user's hand, turn the container body 100 upside down and remove the finishing cap 540, and then apply the contents discharged through the contents-applying member 510 coupled to the lower end of the container body 100 onto the skin. At this time, it is possible to obtain the massaging effect while applying the contents by contacting the contents-applying member 510 to the skin.

As previously described in the above, the present invention, wherein a bottom surface structure of a container body thereof is modified and an applicator part having functions of contents application and massage is coupled thereto, such that contents can be discharged while providing the same usability as a conventional pumping-type cosmetic container, is possible to apply contents onto the skin and to massage the skin through the application part coupled to the bottom surface of the container body, thereby providing user convenience.

Meanwhile, it is also possible that different contents from the contents stored in the container body 100 can be coupled in stick-type. In this case, the contents stored in the container body 100 are for the foundation makeup and the contents coupled to the lower end of the container body 100 are for the color makeup such as a balm, a concealer, a highlighter, etc. Therefore, after the foundation make is performed by discharging the contents stored in the container body 100 through the pumping operation of the pumping member 200 according to the manipulation of the button member 400, the color makeup can be performed using the contents of stick-type coupled to the lower end of the container body 100.

That is, by being configured in that additional different contents for the color makeup can be stored at the lower end of the pumping-type cosmetic container, when using the pumping-type cosmetic container, the problem that a user need not prepare a foundation makeup and a color makeup separately will be solved.

As described above, optimal embodiments have been disclosed in the drawings and the specification. Although specific terms have been used herein, these are only intended to describe the present invention and are not intended to limit the meanings of the terms or to restrict the scope of the present invention as disclosed in the accompanying claims. Therefore, those skilled in the art will appreciate that various modifications and other equivalent embodiments are possible from the above embodiments. Therefore, the technical protective scope of the present invention should be defined by the technical of idea of accompanied claims.

1. A pumping-type cosmetic container having a metal applicator part, comprising:
a container body where contents are stored;
a pumping member coupled to the upper portion of the container body and discharging the contents stored in the container body by means of pumping operation;
a fixation body coupled as encasing the pumping member at the upper portion of the container body, and fixing the pumping member to the upper portion of the container body; and
a button member disposed at the upper portion of the pumping member, and delivering pressure to the pumping member according to a user's pressurization, and inducing the pumping operation,
wherein an applicator part which applies contents onto the skin is coupled to the lower end of the container body, and contents stored in the container body are discharged through pumping operation of the pumping member, and then the contents can be applied onto the skin through the applicator part coupled to the lower end of the container body.

2. The pumping-type cosmetic container having a metal applicator part of claim 1, further comprising:
a contents-applying member which applies contents onto user's skin; a coupling part closing the lower end of the container body and coupled;
a fixation part which extends from the lower end of the coupling part to the lower direction and forming a space where the contents-applying member is inserted, and fixing the contents-applying member inserted; and
a finishing cap encasing the contents-applying member and detachably coupled to the fixation part.

3. The pumping-type cosmetic container having a metal applicator part of claim 2, wherein at the outer circumferential surface of the coupling part of the applicator part is formed an air movement groove moving air to the inner side of the container body such that a piston installed at the lower inner side of the container body can ascend according to the contents usage.

4. The pumping-type cosmetic container having a metal applicator part of claim 2, wherein the contents-applying member is made of any of a brush, a ball, a metal tip, a rubber tip or a puff.

5. The pumping-type cosmetic container having a metal applicator part of claim 1, further comprising:
a container body where contents are stored;
a pumping member coupled to the upper portion of the container body and discharging the contents stored in the container body by means of pumping operation,
wherein the contents of stick-type, different from the contents stored in the container body, are coupled at the lower end of the container body, and the color makeup is followed through the contents of stick-type coupled to the lower end of the container body after the foundation makeup is applied by discharging contents stored in the container body through the pumping member according to the manipulation of the button member.
